(19) United States
(12) Patent Application Publication
(10) Pub. No.: US 2025/0345721 A1
(43) Pub. Date: Nov. 13, 2025

(54) SYSTEMS AND METHODS FOR TREATING SALT SOLUTIONS

(71) Applicant: Occidental Oil and Gas Corporation, Houston, TX (US)

(72) Inventors: Eric DUNN, Houston, TX (US); Anoop V. CHENGARA, Iowa Colony, TX (US); Joseph DeALMEIDA, Richmond, TX (US); David Nigel HARRY, Katy, TX (US); Vrajesh Sanat MEHTA, Richmond, TX (US); Marshall Allan PICKARTS, Cypress, TX (US)

(21) Appl. No.: 18/862,223

(22) PCT Filed: May 3, 2023
(86) PCT No.: PCT/US2023/020887

§ 371 Date: Nov. 1, 2024

Related U.S. Application Data
(60) Provisional application No. 63/337,772, filed on May 3, 2022.

(51) Int. Cl. B01D 3/10; B01D 3/00; B01D 3/14; C02F 1/04; C02F 1/06; C02F 103/10

(52) U.S. Cl. CPC B01D 3/105; B01D 3/007; B01D 3/146; C02F 1/043; C02F 1/06; C02F 2103/10; C02F 2303/10

(57) ABSTRACT

A method for treating a salt solution, the method comprising (i) introducing a liquid motive fluid into an eductor; (ii) drawing vapor from a distillation tank into the eductor, where said drawing reduces the pressure within the distillation tank; (iii) mixing the motive fluid and the vapor within the eductor to produce a liquid stream, where the vapor condenses within said eductor and thereby releases heat and at least a portion of the heat is transferred to the liquid stream; (iv) transferring at least a portion of the heat associated with the liquid stream to a salt solution; and (v) distilling the salt solution within the distillation tank.

### TECHNICAL FIELD

Embodiments of the invention are directed toward systems and methods for treating salt solutions including produced waters.

### BACKGROUND

Water associated with the production of oil and gas is referred to as produced oilfield water or simply produced water. Produced water is generally classified as flowback water or formation water. Flowback water includes spent hydraulic fracturing (frac) fluid, which includes water and related additives used to hydraulically fracture the formation. Formation water includes water that was originally present in the formation. Generally, the relative amount of formation water increases as the amount of flowback water decreases.

The volume of produced water is significant because it is typical to produce multiple barrels of water per barrel of oil produced. In fact, it is not uncommon to produce four to eight barrels of water per barrel of oil produced in some formations. As a result, some oil fields generate tens of millions of barrels of water each day. Some of this water can be reused, especially where water flooding or enhanced oil recovery (EOR) techniques are employed. Nonetheless, an increasing amount of water must be disposed of. The handling and disposal costs associated with produced water can significantly impact the economic viability of any given oil production play.

In addition to the large volume of produced water, other issues associated with produced water complicate its handling and ultimate disposition. For example, the chemical nature of produced water is very complex and can vary based upon the nature of the formation and the production techniques employed. Produced waters generally include significant levels of dissolved and suspended salts in addition to hydrocarbons and gases such as hydrogen sulfide. For example, produced water can include greater than 100,000 mg/L of salt, and can therefore include more than three times the amount of salt found in seawater. In view of the total solids contained in produced water, costly disposal techniques are often required, and these costs are further aggravated by the volume of water that must be managed.

### SUMMARY OF INVENTION

One or more embodiments of the present invention provide a method for treating a salt solution, the method comprising (i) introducing a liquid motive fluid into an eductor; (ii) drawing vapor from a distillation tank into the eductor, where said drawing reduces the pressure within the distillation tank; (iii) mixing the motive fluid and the vapor within the eductor to produce a liquid stream, where the vapor condenses within said eductor and thereby releases heat and at least a portion of the heat is transferred to the liquid stream; (iv) transferring at least a portion of the heat associated with the liquid stream to a salt solution; and (v) distilling the salt solution within the distillation tank.

Yet other embodiments of the present invention provide a process for treating a salt solution, the method comprising (i) condensing a vapor stream to form a first condensed stream and thereby release heat of condensation associated with the vapor stream; (ii) transferring at least a portion of the heat associated with the vapor stream to a salt solution to provide a first heated salt solution; (iii) separating the first heated salt solution into a first vapor stream and a first concentrated salt solution stream, where said separating takes place within a first tank; (iv) transferring the first concentrated salt solution to a second tank; (v) condensing the first vapor stream to form a second condensed stream and thereby release heat of condensation associated with the first vapor stream; (vi) transferring at least a portion of the heat associated with the first vapor stream to the first concentrated salt solution stream to thereby form a second heated salt solution; and (vii) separating the second heated salt solution into a second vapor stream and a second concentrated salt solution stream, where said separating the second heated salt solution takes place with a second tank.

Other embodiments of the present invention provide a multi-stage process for treating a salt solution, the process comprising (i) providing an initial salt solution to an initial distillation stage, (ii) distilling the initial salt solution within the initial distillation stage to thereby produce an initial vapor stream and an initial concentrated salt solution; (iii) transferring the initial vapor stream and initial concentrated salt solution to an intermediary distillation stage; (iv) condensing the initial vapor stream to thereby release the heat of condensation associated with the initial stream; (v) converting, within the intermediary distillation stage, at least a portion of the initial concentrated salt solution an intermediary vapor stream and an intermediary concentrated salt solution; (vi) transferring the intermediary vapor stream and intermediary concentrated salt solution to a final distillation stage, wherein the final distillation stage produces a final vapor stream and a final concentrated salt solution; (vii) condensing the final vapor stream to thereby release the heat of condensation associated with the final vapor stream; (viii) transferring at least a portion of the heat of condensation associated with the final vapor stream to the initial salt solution; and (viii) capturing at least a portion of the final concentrated salt solution.

Still other embodiments of the present invention provide a system for treating a salt solution, the system comprising (i) a distillation tank including a salt solution; (ii) a heat exchanger in thermal communication with the salt solution; (iii) an eductor in fluid communication with the distillation tank and the heat exchanger; and (iv) a pump in fluid communication with the eductor, where the pump is adapted to pump a liquid motive fluid through the eductor, where the eductor is adapted to draw vapor from the distillation tank and mix the vapor with the liquid motive fluid.

Yet other embodiments of the present invention provide a system for treating a salt solution, the system comprising (i) a first distillation tank, where said first distillation tank is adapted for pressure regulation and includes an inlet for receiving a salt solution, an outlet for removing a first concentrated salt solution, and an outlet for removing vapor; (ii) a second distillation tank, where said second distillation tank is adapted for pressure regulation and includes an inlet for receiving a first concentrated salt solution, an outlet for removing a concentrated salt solution, and an outlet for removing vapor, where said second distillation tank is downstream of said first distillation tank, and said outlet for removing a concentrated a salt solution of said first distillation tank is in fluid communication said inlet of said second distillation tank; (iii) a first heat exchanger in thermal communication with the first distillation tank; (iv) a second heat exchanger in thermal communication with the second distillation tank; (v) a first eductor in fluid communication with the second distillation tank, where said first eductor includes an inlet for receiving a liquid motive fluid, an inlet for receiving vapor from the second distillation tank, and an outlet for removing a first heated fluid stream from the first eductor, where the first eductor is adapted to mix vapor from the second distillation tank into the motive fluid to thereby condense the vapor to produce the first heated liquid stream, where outlet for removing a first heated fluid stream is in fluid communication with said first heat exchanger; and (vi) a second eductor in fluid communication with the first heat exchanger, where said second eductor includes an inlet for receiving a liquid motive fluid, an inlet for receiving a liquid stream from the first heat exchanger, and an outlet for removing a second heated fluid stream from the second eductor, where the second eductor is adapted to mix a liquid stream from the first heat exchanger into the motive fluid to thereby produce the second heated liquid stream, where outlet for removing a second heated fluid stream is in fluid communication with said second heat exchanger.

Still yet other embodiments of the present invention provide a method of managing a salt solution, the method comprising (i) providing an initial salt solution; (ii) partially distilling the salt solution to provide a distillate stream and a concentrated salt solution; and (iii) directing the concentrated salt solution to downstream handling.

### DESCRIPTION OF DRAWINGS

FIG. 1 is a cross-sectional side view of a vacuum distillation system according to embodiments of the present invention.

FIG. 2 is a schematic diagram of a distillation system including two eductors according to embodiments of the present invention.

FIG. 3 is a schematic diagram of a distillation system including multiple stages according to embodiments of the present invention.

FIG. 4 is a cross-sectional side view of a pre-treatment system for pre-heating salt solutions prior to treatment by distillation systems of the present invention.

FIG. 5 is a cross-section side view of a pre-treatment system for pre-heating and chemically treating salt solutions prior to treatment by distillation systems of the present invention.

FIG. 6 is a schematic diagram of a water management system according to embodiments of the present invention.

### DETAILED DESCRIPTION

Embodiments of the present invention are based, at least in part, upon the discovery of vacuum distillation systems and related methods for concentrating salt solutions. In one or more embodiments, the salt solutions are concentrated by partially distilling the salt solutions within vacuum distillation systems that advantageously take advantage of one or more eductors to facilitate the distillation.

In one or more embodiments, systems and methods of the invention are employed to manage produced water (i.e. water co-produced with oil and gas production operations). These methods include partially distilling the produced water to produce a highly concentrated aqueous residue stream that can be subsequently managed. In other words, the distillation process produces a concentrated salt solution (i.e. residue stream) that includes a higher dissolved solids content than the produced water stream. Since produced water is often a waste stream that must be managed accordingly, the present invention advantageously provides an efficient solution to managing these waste streams by reducing the overall volume of the salt solution that must be managed. For example, where the concentrated salt solutions are disposed of, the systems and methods of the invention advantageously reduce disposal costs and other disadvantages associated with disposal. Or, given the concentration of the salts within the concentrated salt solutions, the concentrated salt solutions may themselves have value above that of the initially produced water; for example, the concentrated salt solutions may provide an attractive opportunity to separate and capture certain metal ions such as lithium or rare earth metal ions. Additionally, while the produced water streams are concentrated into concentrated salt solutions, the processes employed in one or more embodiments of the invention are manipulated to ensure that the concentrated salt solutions remain below threshold levels for total solids to ensure the ability to handle the concentrated streams in a desired manner.

### Salt Solutions to be Treated

Systems and methods described herein may be described with reference to the solutions that are treated according the invention. While further description of the various solutions is provided below, it should be appreciated that the solutions may be referred to as salt solutions because the solutions are aqueous and include dissolved solids. Relative to the systems and methods disclosed herein, the salt solutions may also be referred to as brine water or saline solutions, and therefore it should be appreciated that terms may be used interchangeably unless otherwise stated. It should also be appreciated that upon treatment of these salt solutions by the systems and methods of the invention, concentrated salt solutions are produced, which concentrated solutions may be also be referred to as concentrated brines or concentrated saline solutions.

### Vacuum Distillation System-Single Stage

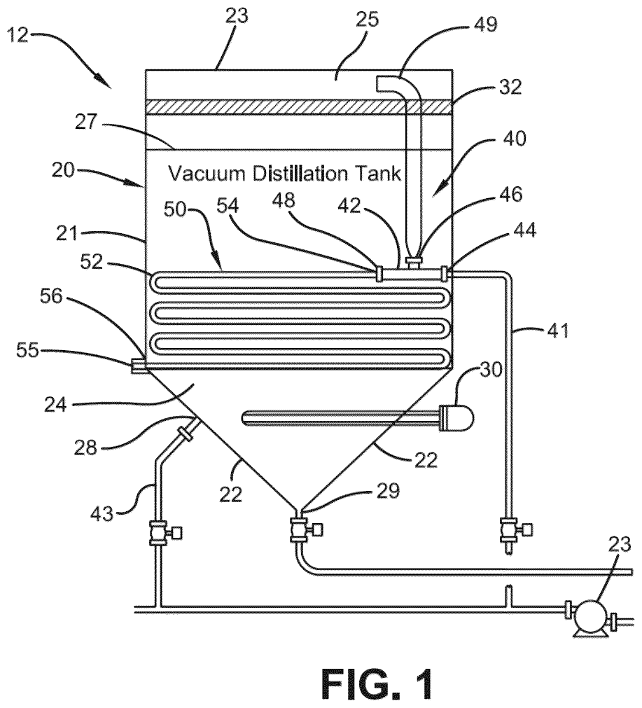

Aspects of the invention can be described with reference to FIG. 1, which shows vacuum distillation system 12, which may simply be referred to as distillation system 12, including tank 20, which may also be referred to as distillation tank 20 or evaporation tank 20. System 12 includes an eductor system 40 and a radiator system 50 disposed within tank 20. Tank 20 includes sidewall 21, bottom 22, and top 23, which together form an internal chamber 24 that is or can be sufficiently sealed to allow for regulation of the pressure within chamber 24. Tank 20 also includes salt solution inlet 28 and bottoms outlet 29. Tank 20 may also include an optional heating element 30 and optional mist eliminator 32. As will be described in greater detail below, liquid within chamber 24 creates a liquid line 27 and a headspace 25 above liquid line 27.

Eductor system 40 includes eductor 42, which may also be referred to as an ejector 42. Eductors, also commonly referred to as ejectors, jet pumps, or jet compressors, are known in the art and generally include those devices that produce vacuum or suction through the Venturi effect as a liquid, which may be referred to as a motive fluid, is forced through a constriction within the eductor. As generally shown in FIG. 1, eductor 42 includes a liquid inlet 44, suction inlet 46 (which may also be referred to as vapor inlet 46), and liquid outlet 48. As will be described in greater detail below, eductor 42 receives a liquid motive fluid through its liquid inlet and draws gases (e.g. water vapor) through it vapor inlet, it then condenses the gases and mixes the condensate with the motive fluid, and the mixture is then expelled through its liquid outlet. Eductor 42 may therefore also be referred to as a condensing liquid-vapor eductor 42.

Liquid inlet 44, which may also be referred to as a pressurized inlet 44, extends through tank sidewall 21 to provide fluid communication outside of tank 20. Eductor system 40 also includes suction tube 49 that is in fluid communication with eductor 42 via suction inlet 46. Suction tube 49 extends into headspace 25 to thereby allow eductor 42 to communicate with headspace 25. While not specifically shown, the skilled person will appreciate that system 12 can include multiple eductor systems 40 that are arranged in series or in parallel.

Radiator system 50, which may also be referred to as heat exchanger 50, is in fluid communication with eductor system 40. Radiator system 50 includes radiator conduit 52, which may also be referred to as radiator coil 52. Radiator conduit 52 includes inlet 54, which can be directly received by liquid outlet 48 of eductor 42, and a liquid outlet 55, which can extend through sidewall 21 to provide fluid communication outside of tank 20. As shown, radiator conduit 52 has a generally elongated body that offers desirable surface area within chamber 24. In one or more embodiments, eductor 42 and radiator system 50 are disposed below liquid line 27. It will also be appreciated that heat exchanger 50 can be disposed external to tank 20 while remaining in thermal communication with the salt solution within tank 20; for example, heat exchanger can be in thermal communication with an inlet line into tank 20 and thereby transfer heat to the incoming salt solution before entry into the tank 20.

During operation, a pressurized water stream, which may also be referred to as a motive fluid, enters vacuum distillation system 12 via conduit 41. Specifically, the pressurized water stream enters eductor 42 via pressurized inlet 44 and undergoes constriction within eductor 42. This constriction causes a decrease in the pressure of the water stream and thereby causes suction forces at suction inlet 46. As the skilled person will appreciate, suction inlet 46 is in fluid communication with the constriction (not shown) within eductor 42. As a result of the suction forces (i.e. forces that cause fluid flow into eductor 42 through suction inlet 46), fluids (namely gases such as water vapor) within headspace 25 are drawn into eductor 42 through suction tube 49. Since chamber 24 is sufficiently sealed, headspace 25 experiences a reduction in pressure as a result of gases within headspace 25 being drawn into eductor 42 (i.e. suction causes a partial vacuum within headspace 25). This reduced pressure facilitates distillation of the salt solution within tank 20; in other words, the partial vacuum allows the water to be distilled at temperatures lower than ambient conditions.

In conjunction with the foregoing, a brine water stream (which may also be referred to as a saline or mineral water stream) enters tank 20 via conduit 43 at tank inlet 28. As shown, the contaminated water fills a portion of the volume of chamber 24 to provide the liquid line 27 that is above eductor 42; this liquid line is a parameter that defines a head space 25. Brine water within tank 20 is heated to a temperature sufficient to evaporate at least a portion of the water under the vacuum provided by eductor system 40. The distillation process can be facilitated by use of one or more eliminators 32, which help reduce possible liquid carryover into the distillate. As the skilled person appreciates, the temperature necessary to boil the water (i.e. distill the water) is dependent upon the pressure within headspace 25, which is reduced by operation of eductor system 40, as explained above. The skilled person also appreciates that by distilling the water, the water is separated from the minerals and/or salts in the brine water to thereby create a vapor phase that is desalinated (i.e. decontaminated).

The heat required to boil water within tank 20 can be supplied by tank heater 30. In one or more embodiments, this heat is supplemented by, or completely supplied by, heat released by the condensation of water vapor pulled from headspace 25 by eductor system 40. With reference again to the operation of eductor system 40, it was explained above that gases within headspace 25 are drawn through suction tube 49 into eductor 42. As the skilled person will appreciate, these gases include water vapor within headspace 25 by virtue being evaporated within tank 20 (i.e. the distillation process). This water vapor, upon entering eductor 42, becomes entrained in the fluid (i.e. it is mixed into the pressurized water stream acting as the motive fluid) traveling through eductor 42. Also, the vapor is condensed within eductor 42 (i.e. eductor 42 is a condensing liquid-vapor eductor). The skilled person appreciates that one or more factors may lead to the condensation of the vapor within the eductor. For example, characteristics of the motive fluid, including its volume and temperature, may be sufficient to overcome the heat associated with the vapor, including the heat of condensation. In lieu of or in combination therewith, the workings of the eductor may facilitate condensation of the vapor. For example, the fluid path within eductor 42 not only includes constriction (as noted above), but also expansion downstream of the constricted flow path due to the fact the motive fluid is moving at supersonic speeds within the eductor. This expansion, which causes an increase in pressure, promotes condensation of the water vapor, which provides heat to the pressurized fluid stream.

In any event, the mixture of the motive fluid and the condensed vapor produce a heated water stream that is expelled from the outlet of the eductor. It should also be appreciated that latent heat that is associated with the condensation of the water vapor is transferred to the water stream (i.e. the motive fluid stream) and therefore the liquid stream exiting eductor 42 via liquid outlet 48 includes heat energy associated with the condensation of the water vapor pulled from headspace 25. As the heated water stream flows through radiator conduit system 50, at least a portion of the heat energy is transferred to the brine water through radiator conduit 52 (i.e. radiator conduit system 50 serves as a heat exchanger to transfer at least a portion of the heat energy of the fluid flowing through radiator coil 52 to the contaminated water within tank 20). As noted above, this heat, optionally together with heat from heater 30, increases the temperature of the contaminated water above the boiling point of the water relative to the pressure in headspace 25.

Concentrated contaminated water, which may also be referred to as brine, is removed from vacuum distillation tank 20 via bottoms outlet 29.

### Vacuum Distillation System-Two-Stage System

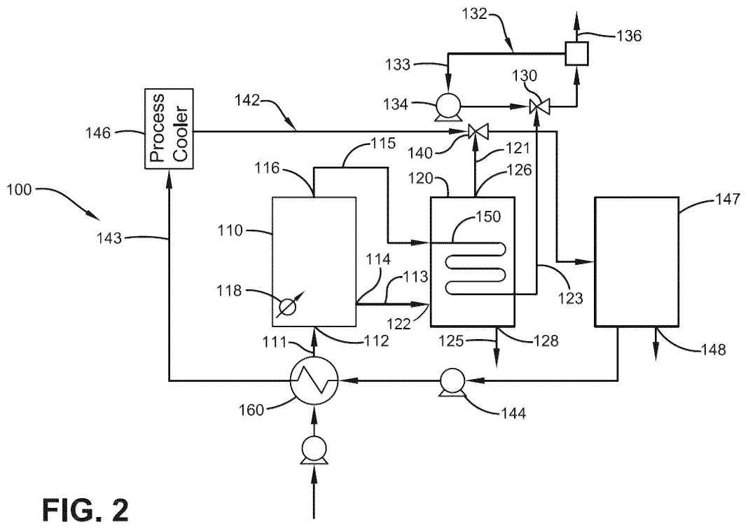

In one or more embodiments, a vacuum distillation system for concentrating the produced water stream according to aspects of the present invention can be described with reference to FIG. 2. As shown, vacuum distillation system 100, which may simply be referred to as distillation system 100, includes a first distillation tank 110, a second distillation tank 120, a liquid-liquid eductor 130, and a condensing liquid-vapor eductor 140. As described above, the distillation tanks may be referred to as vacuum distillation tanks or evaporation tanks, and the eductors may be referred to as ejectors. First distillation tank 110 includes liquid inlet 112, liquid outlet 114, and vapor outlet 116. Second distillation tank 120 includes liquid inlet 122, concentrated brine outlet 128, and vapor outlet 126. First and second distillation tanks 110, 120 are adapted to include an internal chamber that is or can be sufficiently sealed to allow for regulation of the pressure within the chamber. Liquid-liquid eductor 130 is adapted to receive a liquid motive fluid and draw liquid from a distinct source into the eductor and mix the drawn liquid with the motive fluid. Condensing liquid-vapor eductor 140 is adapted to receive a liquid motive fluid and draw gases (e.g. water vapor) from a distinct source into the eductor, condense the gases, and mix the condensate with the motive fluid.

First distillation tank 110 is in fluid communication with a second distillation tank 120 via conduit 113. Second distillation tank 120 is in fluid communication with condensing liquid-vapor eductor via conduit 121. A vapor-line radiator system 150, which may simply be referred to a radiator system 150 or radiator 150 or heat exchanger 150, is disposed within second distillation tank 120 and is in fluid communication with first distillation tank 110 via conduit 115. Vapor-line radiator system 150 is also in fluid communication with liquid-liquid eductor 130 via conduit 123. It will be appreciated that radiator 150 includes a conduit or coil through which the distillate flows, cools, and is condensed. The conduit or coils generally include an elongated body that offers desirable surface area and contact with the fluids within the tank in which the radiator is disposed.

Liquid-liquid eductor 130, which may simply be referred to as eductor 130, is in fluid communication with motive loop 132, which includes conduit 133, pump 134, and liquid outlet 136. Condensing liquid-vapor eductor 140, which may simply be referred to as eductor 140, is in fluid communication with motive loop 142, which includes conduit 143, pump 144, liquid outlet 148, storage tank 147, and a cooler 146. Conduit 143 and a produced water inlet line 111 are in thermal communication via heat exchanger 160.

During operation, a motive fluid, such as water, is circulated through motive loop 142 at a desired pressure that is regulated by pump 144. As the motive fluid is forced through eductor 140, the operation of the eductor creates a partial vacuum that draws vapor from second distillation tank 120 (i.e. vapor is drawn through vapor outlet 126 of tank 120 via conduit 121). The vapor drawn from second distillation tank 120 is entrained into the motive fluid and condensed to become part of the motive fluid circulating through loop 142. In one or more embodiments, the motive fluid entering the eductor adequately absorbs the heat of condensation of the vapor to thereby condense the vapor. As the skilled person appreciates, several factors can contribute to the ability of the motive fluid to overcome the heat associated with the vapor including, but not limited to, the temperature and volume of the motive fluid being mixed with the vapor.

In any event, at least a portion of the heat associated with the condensation of the vapor (i.e. vapor drawn from tank 120) is transferred to the motive fluid. While heat is transferred to the motive fluid, the stream exiting eductor 140 remains in the liquid phase. This heat, which is the latent heat of condensation (i.e. energy released) associated with the condensation of the vapor drawn from second distillation tank 120, can be at least partially captured as will be described in greater detail below. The amount of liquid within circulation loop 142 is regulated by overflow storage tank 147 and the withdrawal of fluids through outlet 148. As the skilled person appreciates, vapor drawn from second distillation tank 120 lowers the pressure within second distillation tank 120 and thereby facilitates the distillation process by lowering the temperature required to achieve separation within second distillation tank 120.

In a similar fashion, a motive fluid, such as water, is circulated through motive loop 132 at a desired pressure that is regulated by pump 134. As the motive fluid is forced through eductor 130, the operation of the eductor creates a partial vacuum that draws fluid from vapor-line radiator system 150 (i.e. liquid condensed within radiator system 150 is drawn through conduit 123). The liquid drawn from radiator 150 is entrained into the motive fluid and becomes part of the motive fluid circulating through loop 132. As liquid water is drawn from radiator 150, vapor is drawn from the headspace of tank 110 into radiator 150. The skilled person will appreciate that the condensation of the vapor within radiator 150 maintains reduced pressure within with tank 110, which draws vapor into radiator 150 and facilitates distillation within tank 110 (by reducing pressure within tank 110). The skilled person will also appreciate that removal of liquid water from radiator 150 via eductor 130 will replenish the surface area within radiator 150 and allows condensation of the subsequent vapor entering radiator 150 to occur. In any event, the amount of liquid within circulation loop 132 is regulated by withdrawal of fluids through outlet 136.

A salt solution is introduced to first distillation tank 110 at liquid inlet 112 via feed line 111. As suggested above, heat is transferred, via heat exchanger 160, from the motive fluid circulating through motive loop 142 to the salt solution being introduced to first distillation tank 110 to thereby preheat the salt solution before entering first distillation tank 110. The flow of salt solution into first distillation tank 110 is regulated to create a liquid level within tank 110 and a head space above the liquid level. The pressure within tank 110, which as noted above is regulated (i.e. reduced) by vapor drawn into radiator 150, facilitates distillation. As described above, condensation of vapor within radiator 150 reduces the pressure within tank 110 and drives vaporization of at least a portion of the water within tank 110 to thereby separate a portion of the water vapor from the remaining brine. Stated differently, temperature and pressure within tank 110 drive distillation of the salt solution, and the distillate (i.e. vapor) is drawn from the head space through vapor outlet 116 via conduit 115 to radiator 150. The residue within tank 110, which is concentrated brine, is removed from tank 110 via liquid outlet 114 via conduit 113. The temperature of the salt solution (i.e. the liquid) within tank 110 can be further regulated by heat transferred from utility heater 118.

As indicated above, concentrated brine is transferred from first distillation tank 110 to second distillation tank 120 via conduit 113 to create a liquid level and a head space within second distillation tank 120. Vapor removed from first distillation tank 110 via conduit 115 is pulled through radiator system 150, which is in thermal communication with the concentrated brine within second distillation tank 120. Energy associated with the vapor, including latent heat of condensation associated with the vapor as it cools and condenses within radiator 150, is transferred to the concentrated brine within second distillation tank 120. The temperature of the liquid within distillation tank 120, as well as the pressure within tank 120 (which is regulated by vapor being drawn into condensing liquid-vapor eductor 140), drive separation of the water vapor from the remaining brine. Stated differently, temperature and pressure within tank 120 drive further distillation of the concentrated brine, and the distillate (i.e. vapor) is removed from the head space through vapor outlet 126 via conduit 121, and the residue, which is concentrated brine, is removed from tank 120 via concentrated brine outlet 128 via conduit 125.

It will be appreciated that since the concentration of the brine within the second distillation tank 120 is greater than the concentration of the brine within the first distillation tank 110, the conditions required to distill the solution within the second distillation tank 120 increases by requiring higher temperature or reduced pressure. In one or more embodiments, the temperature of the solution within the second tank is lower than the temperature of the solution within the first tank, and therefore the pressure within the second distillation tank is lower than the first. Stated differently, the temperature of first distillation tank can be represented by T₁, the temperature of the second distillation tank can be represented by T₂, the pressure within first distillation tank can be represented by P₁, the pressure within the second distillation tank can be represented by P₂, and during operation of the system, T₁>T₂, and P₁>P₂.

### Vacuum Distillation System-Multi-Stage

In one or more embodiments, salt solutions are concentrated by employing a multi-stage vacuum distillation system. Generally, the multi-stage system includes a first stage (which may also be referred to as an initial stage), where a salt solution is distilled to produce a vapor stream and a concentrated salt solution stream. The vapor is condensed and at least a portion of the heat of condensation is transferred to the concentrated salt solution in an intermediary stage. Distillation takes place in the intermediary stage to produce a vapor stream and a concentrated salt solution stream. The vapor produced in the intermediary stage is condensed and at least a portion of the heat of condensation is transferred to the concentrated salt solution in a final stage where distillation again takes place to produce a final vapor stream and a final concentrated salt solution stream. The final vapor is condensed, for example within a condensing eductor, and at least a portion of the heat of condensation associated with the final vapor stream is transferred back to the initial stage. The intermediary stage may include multiple substages where distillation takes place in multiple substages operating in series with each successive substage producing a vapor stream and a concentrated salt solution stream, and condensation of the vapor stream releasing heat of condensation that is at least partially transferred to the subsequent substage. This process may also be referred to as multi-effect distillation process.

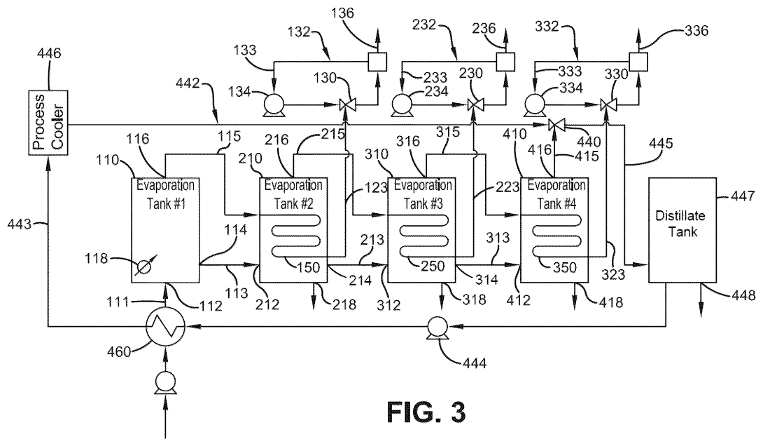

An exemplary multi-stage vacuum distillation system, which may also be referred to as multi-stage distillation system, can be described with reference to FIG. 3. As shown, multi-stage system 100 includes four stages represented by a first vacuum distillation tank 110, a second vacuum distillation tank 210, a third vacuum distillation tank 310, and a fourth vacuum distillation tank 410. As with other embodiments, the vacuum distillation tanks may be referred to as distillation tanks or evaporation tanks.

Consistent with the vacuum distillation tanks described with respect to FIG. 1, the vacuum distillation tanks 110, 210, 310, 410 each include liquid inlets 112, 212, 312, and 412, respectively, and vapor outlets 116, 216, 316, and 416, respectively. Tanks 110, 210, and 310 each include liquid outlets 114, 214, and 314, respectively, and tanks 210, 310, and 410 each respectively include concentrated brine outlets 218, 318, and 418.

Tank 110 is in fluid communication with first liquid-liquid eductor 130. Tank 210 is in fluid communication with second liquid-liquid eductor 230. Tank 310 is in fluid communication with third liquid-liquid eductor 330. And tank 410 is in fluid communication with condensing liquid-vapor eductor 440.

First liquid-liquid eductor 130, which may simply be referred to as first eductor 130, is in fluid communication with motive loop 132, which includes conduit 133, pump 134, and liquid outlet 136. Second liquid-liquid eductor 230, which may simply be referred to as second eductor 230, is in fluid communication with motive loop 232, which includes conduit 233, pump 234, and liquid outlet 236. Third liquid-liquid eductor 330, which may simply be referred to as third eductor 330, is in fluid communication with motive loop 332, which includes conduit 333, pump 334, and liquid outlet 336.

Condensing liquid-vapor eductor 440, which may simply be referred to as liquid-vapor eductor 440, is in fluid communication with motive loop 442, which includes conduit 443, pump 444, cooler 446, and overflow storage tank 447, which includes liquid outlet 448. Conduit 443 and a produced water inlet line 111 are in thermal communication via heat exchanger 460.

A vapor-line radiator system 150 is disposed within second distillation tank 210, and radiator system 150 is in fluid communication with first distillation tank 110 via conduit 115 and with liquid-liquid eductor 130 via conduit 123. A second vapor-line radiator system 250 is disposed within third distillation tank 310, and radiator system 250 is in fluid communication with second distillation tank 210 via conduit 215 and with liquid-liquid eductor 230 via conduit 223. A third vapor-line radiator system 350 is disposed within fourth distillation tank 410, and radiator system 350 is in fluid communication with third distillation tank 310 via conduit 315 and with liquid-liquid eductor 330 via conduit 323. As provided in other embodiments, the radiators or radiator systems may be referred to as heat exchangers.

During operation, a motive fluid, such as water, is circulated through motive loop 132 at a desired pressure that is regulated by pump 134. As the motive fluid is forced through eductor 130, the operation of the eductor creates a partial vacuum that draws fluid from vapor-line radiator system 150 (i.e. liquid condensed within radiator system 150 is drawn through conduit 123). The liquid drawn from radiator 150 is entrained into the motive fluid and becomes part of the motive fluid circulating through loop 132. The latent heat of condensation (i.e. energy released) from the condensation of the vapor within radiator 150 is captured as will be described in greater detail below. The amount of liquid within circulation loop 132 is regulated by withdrawal of fluids through outlet 136. As discussed above with respect to FIG. 2, while liquid is drawn from radiator 150, the condensation of vapor within radiator 150 draws vapor into radiator 150 and optionally reduces the pressure within first distillation tank 110, which can thereby facilitate the distillation process within tank 110.

Similarly, motive fluid, such as water, circulates through motive loops 232 and 332, respectively, at desired pressures regulated by pumps 234, 334, respectively. The forced movement of the motive fluid through eductors 230, 330, respectively, creates a partial vacuum that draws liquid from the respective vapor-line radiator systems 250, 350. This liquid is entrained within the motive fluid within loops 232, 332, respectively, and the overall amount of fluid within loops 232, 332, respectively, is regulated by the removal of fluid through outlets 236, 336, respectively. While liquid water is drawn from radiators 250, 350, condensation of vapor within radiators 250, 350 draws vapor from tanks 210, 310, into the respective radiators and also reduces the pressure within tanks 210, 310, respectively, to thereby facilitate distillation of the brine present in the respective tanks.

With regard to motive loop 442, a motive fluid, such as water, is likewise circulated at a desired pressure that is regulated by pump 444. As the motive fluid is forced through eductor 440, the operation of the eductor creates a partial vacuum that draws vapor from fourth distillation tank 410. The vapor is condensed and becomes entrained into the motive fluid circulating through loop 442. The amount of liquid within circulation loop 442 is regulated by overflow storage tank 447 and the withdrawal of fluids through outlet 448. As the skilled person appreciates, vapor drawn from fourth distillation tank 410 lowers the pressure within fourth distillation tank 410 and thereby facilitates the distillation process by lowering the temperature required to achieve separation within fourth distillation tank 410.

The heat associated with the condensation of the vapor (i.e. vapor drawn from tank 410) is at least partially transferred to the motive fluid. While heat is transferred to the motive fluid, the stream exiting eductor 440 remains in the liquid phase. This heat, which is the latent heat of condensation (i.e. energy released) associated with the condensation of the vapor drawn from fourth distillation tank 410, can be at least partially captured as will be described in greater detail below.

A salt solution is introduced to first distillation tank 110 at liquid inlet 112 via feed line 111. Heat is transferred, via heat exchanger 460, from the motive fluid circulating through motive loop 442 to the salt solution being introduced to first distillation tank 110 to thereby preheat the salt solution before entering first distillation tank 110. The flow of salt solution into first distillation tank 110 is regulated to create a liquid level within tank 110 and a head space above the liquid level. level. The pressure within tank 110, which as noted above may be regulated (i.e. reduced) by vapor drawn into radiator 150, facilitates distillation. As described above, condensation of vapor within radiator 150 may reduce the pressure within tank 110 and help drive vaporization of at least a portion of the water within tank 110 to thereby separate a portion of the water vapor from the remaining brine. Stated differently, temperature and pressure within tank 110 drive distillation of the salt solution, and the distillate (i.e. vapor) is drawn from the head space through vapor outlet 116 via conduit 115 to radiator 150. The residue within tank 110, which is concentrated brine, is removed from tank 110 via liquid outlet 114 via conduit 113. The temperature of the salt solution (i.e. the liquid) within tank 110 can be further regulated by heat transferred from utility heater 118.

The concentrated brine transferred from first distillation tank 110 to second distillation tank 210 creates a liquid level and a head space within second distillation tank 210. The brine within tank 210 is heated by the transfer of heat associated with the condensation of vapor removed from first distillation tank 110 within radiator system 150, which is in thermal communication with the concentrated brine within second distillation tank 210. The temperature of the liquid within distillation tank 210, as well as the pressure within tank 210 (which is regulated by vapor being drawn into eductor 230), drive separation of the water vapor from the remaining brine. That is, temperature and pressure within tank 210 drive further distillation of the concentrated brine, and the distillate (i.e. vapor) is removed from the head space through vapor outlet 216 via conduit 215, and the residue, which is concentrated brine, is removed from tank 210 via concentrated brine outlet 214 via conduit 213.

A similar process takes place with respect to the concentrated brine transferred to third distillation tank 310, wherein heat is transferred to the concentrated brine from the condensing vapor within radiator system 250. This heat, together within the reduction in pressure caused by the suction forces exerted by eductor 330, drives further distillation of the concentrated brine within tank 310, and the distillate (i.e. vapor) is removed from the head space through vapor outlet 316 via conduit 315, and the concentrated brine residue is removed from tank 310 via concentrated brine outlet 314 via conduit 313.

Similarly, the concentrated brine transferred to distillation tank 410 is further heated by heat transferred from the evaporating vapor within radiator system 350. This heat, together within the reduction in pressure caused by the suction forces exerted by eductor 440, drives further distillation of the concentrated brine within tank 410, and the distillate (i.e. vapor) is removed from the head space through vapor outlet 416 via conduit 415. The concentrated brine residue is ultimately removed from tank 410 via discharge outlet 418. At this point, the concentrated brine is removed from the brine concentration system and can be routed to downstream uses or disposal as outlined above.

As also shown in FIG. 3, distillation tanks 210 and 310 include discharge outlets 218 and 318, respectively. Accordingly, the concentrated brine can optionally be removed from the brine concentration system at any of distillation tanks 210, 310 and 410. The location at which it may be desirable to remove the concentrated brine from the brine concentration system may depend on several factors including, but not limited to, the total solids (both dissolved and suspended) within the concentrated brine at any given location. In this regard, each distillation tank may include a device to monitor one or more properties of the brine to ascertain the total solids and/or one or more other relevant properties such as viscosity. Removal of the brine through one or more of the discharge outlets may take place, based upon data gathered relative to the brine, by decisions made in real time or via a pre-selected program.

It will be appreciated that as the concentration of the brine increases with each stage (i.e. as the concentrated brine solution is transferred to each successive distillation tank), the conditions required to distill the solution increase by requiring higher temperatures or reduced pressure. In one or more embodiments, the temperature of the solution within each successive tank decreases and the pressure within each successive tank decreases. Stated differently, the temperature of the initial distillation tank can be represented by Tᵢₙᵢₜᵢₐₗ and the pressure within initial distillation tank can be represented by Pᵢₙᵢₜᵢₐₗ; the temperature of the intermediary distillation tanks (collectively) can be represented by T_{intermediary}, and the pressure within the intermediary distillation tanks (collectively) can be represented by P_{intermediary}; the temperature of the final distillation tank can be represented by T_{final}, the pressure within the final distillation tank can be represented by P_{final}, and during operation of the system, Tᵢₙᵢₜᵢₐₗ>T_{intermediary}>T_{final} and Pᵢₙᵢₜᵢₐₗ>P_{intermediary}>P_{final}. Where the intermediary stage includes multiple substages (i.e. multiple distillation tanks in series with heat of condensation and concentrated brine transferred successively downstream to the tanks in series), the temperature and pressure at the first substage can be represented as T_{sub-1} and P_{sub-1}, respectively, and each successive stage as T_{sub-1+n} and P_{sub-1+n}, respectively, where n represents the number of the sub stages beyond the first substage. Accordingly, during operation of the system, the temperature and pressure profile within the intermediary stage can be defined as T_{sub-1}>T_{sub-1+n}, and P_{sub-1}>P_{sub-1+n}, with n being an integer representing each successive substage beyond the first and continuing in series for each additional substage.

### Pre-Heating System and Process

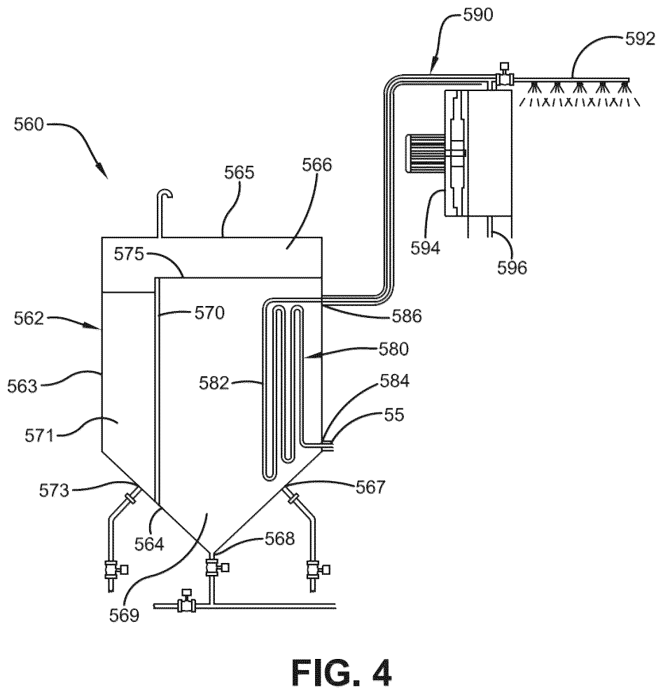

Embodiments of the invention also provide a system and method for preheating the salt solutions prior to introducing the salt solutions to, for example, a distillation tank as described with reference to FIG. 1. Accordingly, and with reference to FIGS. 1 and 4, the heated water stream is routed out of tank 20 (i.e. through radiator outlet 56) to a pre-heating system 560 via conduit 55. Pre-heating system 560 includes a tank 562 having a radiator system 580 disposed therein.

Feed tank 562 includes sidewall 563, bottom 564, and optional top 565, which define internal chamber 566. Feed tank 562 also includes contaminated water inlet 567 and pre-heated contaminated water outlet 568. In one or more embodiments, feed tank 562 includes a weir 570 and an oil outlet 573 positioned on the opposite side of weir 570 relative to untreated contaminated water inlet 567. Weir 570 divides chamber 566 into a water sub-chamber 569 and an oil sub-chamber 571.

Radiator system 580, which may also be referred to as heat exchanger system 580, includes radiator conduit 582, which may also be referred to as radiator coil 582. Radiator conduit 582 includes a body that extends through a portion of tank 562 in an elongated path to offer desirable surface area within water sub-chamber 569. Radiator coil 582 is in fluid communication with conduit 55 via inlet 584, which extends though sidewall 563. Radiator coil 582 exits tank 562 at outlet 586, which extends out of sidewall 563.

In one or more embodiments, radiator outlet 586 is optionally in fluid communication with a water evaporation system 590. Water evaporation system 590 may include a mister 592, which may also be referred to as a dispersing device 592, that can operate in conjunction with the outlet air stream of a radiator cooler 594. System 590 may also include an overflow liquid outlet 596, which can be in fluid communication with a holding tank (not shown in FIG. 4). In alternate embodiments, radiator outlet 586 is in fluid communication with a holding tank (not shown in FIG. 4), which may be in fluid communication with liquid inlet 44 of eductor system 40 (see FIG. 1).

During operation, untreated contaminated water stream flows through inlet 567 and enters water sub-chamber 569 where the water comes into contact with radiator system 580. In conjunction therewith, the heated water stream from distillation tank 20 (FIG. 1) is routed though radiator conduit 582 via inlet 584 and flows through radiator conduit 580 to outlet 586. At least a portion of the heat energy within the heated water stream is transferred to the untreated contaminated water within sub-chamber 569 to thereby pre-heat the water. The pre-heated water is removed from pre-treatment tank 562 via outlet 568, and the pre-treated water can then be directed toward vacuum distillation system 12 (FIG. 1) for decontamination within vacuum distillation tank 20 as described above.

The constituents within the water stream that are less dense than water, such as oils, migrate to the surface of liquid line 575 of chamber 566 where these constituents ultimately migrate over weir 570 into oil sub-chamber 571 of tank 562. These materials can be collected within sub-chamber 571 and ultimately removed from tank 562 via oil outlet 573. The skilled person will appreciate that the water level within sub-chamber 569 can be maintained at the height of weir 570 to thereby maintain the flow of lighter constituents (e.g. oils) into sub-chamber 571 without forcing an undesirable amount of water into sub-chamber 571.

In one or more embodiments, the water stream that is routed through radiator conduit system 580 and out of pre-treatment system 560 via outlet 586 can be routed to several locations. For example, the heated water stream, which includes water that was decontaminated within distillation tank 20 (i.e. distillate from the distillation process that was subsequently entrained in the water stream), can be delivered to storage for subsequent return to the environment such as by underground injection or delivery to surface water. In these or other embodiments, a portion of the water can be returned to the process by routing it to inlet 44 of eductor 40. This may include pressurizing the water by way of, for example, pump 23 (shown in FIG. 1). In these or other embodiments, a portion of the heated water stream removed from radiator conduit system 580 can be directed toward evaporator system 590 where the heated water stream can be dispersed into the atmosphere through dispersing device 592, which may include, for example, multiple sprayers or misters. The evaporation process can be promoted by the air flow that can be supplied by radiator cooler 594. Excess water not passed through dispersing device 592 can be routed through overflow tube 596 to tank storage or back into the process as describe above.

### Pre-Treatment with CO2 Treatment

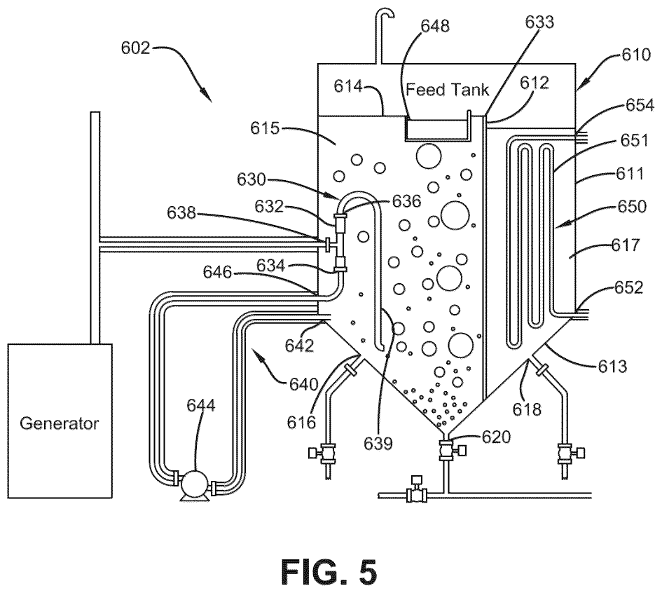

In yet other embodiments, the pre-treatment of the contaminated water, as described above with reference to FIG. 4, can include treatment with carbon dioxide, which offers the benefit of not only pre-heating and chemically-pretreating the water, but also sequestering carbon dioxide. These embodiments can be described with reference to FIG. 5, which shows pre-treatment system 602 including pre-treatment tank 610, which includes weir 612, which together with the outer wall 611 and bottom 613, forms first sub-chamber 615 and second sub-chamber 617. First sub-chamber 615 may also be referred to as chemical treatment sub-chamber 615, and second sub-chamber 617 may also be referred to as a pre-heating sub-chamber 617.

A circulation system 630 is disposed within first sub-chamber 615 and includes eductor 632 having liquid inlet 634, liquid outlet 636, and suction inlet 638. Liquid inlet 634 of eductor 630 is in fluid communication with a pressurization loop 640, which includes draw inlet 642, pump 644, and pressurized-stream outlet 646. Liquid outlet 636 is in fluid communication with a dispersing device 639, which may include a sparge tube. A trough 648 is disposed within first sub-chamber 615 at near the top 633 of weir 612. A contaminated water inlet 616 and a slurry outlet 620 provide respective inlet and outlet from first sub-chamber 615.

A radiator conduit system 650, which may also be referred to as heat exchanger system 650, is disposed within second sub-chamber 617 and includes inlet 652 and outlet 654. Radiator conduit 650 includes a body 651 that extends through a portion of second sub-chamber 617 in an elongated path to offer desirable surface contact within second sub-chamber 617. Second sub-chamber 617 includes a pre-treated contaminated water outlet 118.

During operation, untreated contaminated water stream enters tank 610 via inlet 616 and enters first sub-chamber 615. As the contaminated water fills first sub-chamber 617, the water level rises within first sub-chamber 617 to height 633, which is consistent with the height of weir 612 to form liquid line 619.

The constituents within the water stream that are less dense than water, such as oils, migrate to the surface of liquid line 619 and at least a portion enter trough 648 and can be subsequently recovered via an outlet (not shown).

In conjunction with contaminated water entering first sub-chamber 615, water is drawn from first sub-chamber 615 by pressurization loop 640. Namely, water within sub-chamber 615 is drawn by pump 644 through draw inlet 642 to form a pressurized stream that is delivered through pressurized-stream outlet 646 to eductor 632, where the pressurized water enters liquid inlet 634 of eductor 632. The pressurized water stream undergoes constriction within eductor 632, which causes a decrease in the pressure of the water stream and thereby causes suction forces to pull fluids through suction inlet 638. As the skilled person will appreciate, suction inlet 638 is in fluid communication with the constriction (not shown) within eductor 632. As a result of these suction forces, fluids (namely gases) are drawn into eductor 632.

According to embodiments of the present invention, suction inlet 638 draws flue gas from a nearby combustion process. The flue gas may optionally be pre-treated prior to being drawn into eductor 632. In other embodiments, eductor 632 may draw flue gas directly from a combustion process. In either event, the flue gas is drawn into eductor 632 and becomes entrained into pressurized water stream flowing through eductor 632. The skilled person also appreciates that the fluid path within eductor 632 not only includes constriction (as noted above), but also expansion downstream of the constricted flow path. This expansion, which causes an increase in pressure, provides fluid forces that force the water stream (which includes entrained flue gases) out of dispersing device 639 into the contaminated water within first sub-chamber 615. The carbon dioxide within the flue gas stream reacts with constituents within the contaminated water stream to achieve mineral carbonation, which forms solid carbonates that precipitate out of solution and are gravity fed to the bottom of sub-chamber 615. These solids, together with other heavy constituents within the water stream, can be removed from sub-chamber 615 via slurry outlet 620.

Meanwhile, the water spills over weir 612 and enters second sub-chamber 617 where it can be pre-heated in a manner described above. Namely, the heated water stream from distillation tank 20 (FIG. 1) is routed to radiator conduit system 650 within sub-chamber 617 via inlet 652, and this heated water flows through radiator conduit 651 to outlet 654. At least a portion of the heat energy within the heated water stream is transferred to the contaminated water within second sub-chamber 617 to thereby pre-heat the water. Water can then be removed from sub-chamber 617 via outlet 618 and routed to vacuum distillation system 12 for decontamination as described above. The skilled person will appreciate the water stream being removed from second sub-chamber 617 is both chemically treated and pre-heated prior to delivery to vacuum distillation system 12. It will also be appreciated that heated water leaving system 602 (i.e. exiting radiator system 650 via outlet 654) can be routed to storage tanks (not shown), and/or back to vacuum distillation system 12 for use within eductor 42 (e.g. after pressurization within pump 23), and/or released to the atmosphere via an evaporation system 590 as described with reference to FIG. 4.

### Vacuum-Insulated Conduits

In one or more embodiments, the transfer of fluids within the systems described above can take place within vacuum insulated conduits, which offer the advantage of minimizing energy losses within the system and between the various sub-systems. For example, conduit 55, through which heated water stream travels from tank 20 (of vacuum distillation system 12) to tank 562 (of pre-heating system 560) or tank 611 (of pre-treatment system 602), can include a vacuum-insulated conduit. Similarly, pressurization loop 640 may employ vacuum-insulated conduit. And, conduit routing heated water stream to evaporation system 590 can employ vacuum-insulated conduit.

### Industrial Applicability

The systems and processes of the present invention can be employed to treat a variety of salt solutions. In one or more embodiments, treatment of the solutions produces a distillate stream that is substantially free of dissolved solids and concentrated brine stream that includes total dissolved solids that are substantially greater than the feed stream (i.e. the salt solution fed to the process). In one or more embodiments, the distillate stream includes less than 1000 mg/L, in other embodiments less than 100 mg/L, in other embodiments less than 10 mg/L, and in other embodiments less than 1 mg/L of dissolved solids.

As indicted above, the salt solutions that are treated according the present invention include aqueous solutions that include dissolved solids. For example, these salt solutions can include greater than 1000 mg/L, in other embodiments greater than 10,000 mg/L, in other embodiments greater than 25,000 mg/L, in other embodiments greater than 50,000 mg/L, and in other embodiments greater than 100,000 mg/L total dissolved solids. These salt solutions may also include suspended solids. Exemplary salt solutions that can be treated according to the present invention include, without limitation, brackish water, brine water, sea water, playa lake water, closed-basin water, mineral water, industrial process water, sea water contaminated with salt solutions, produced water, and weighted brine. These salt solutions can include naturally-occurring salt solutions or contaminated salt solutions, where the latter refers to man-made salt solutions or salt solution that are formed by the introduction of one or more species into a naturally occurring salt solution (e.g. a sea water contaminated with a weighted brine). In one or more embodiments, the salt waters treated by the systems and processes of the present invention include hydrocarbon materials entrained in the water; e.g. they may include entrained or suspended oils.

As indicated above, one or more advantageous aspects of the invention include the fact that the methods and systems of the invention can be used to concentrate salt solutions and thereby produce a concentrated salt solution. These concentrated salt solutions can then advantageously be directed to one or more downstream handling operations. It will be appreciated that the concentrated solutions have reduced volume relative to the initial salt solutions that are treated by the present invention and that several advantages stem from this reduced volume.

For example, in those embodiments where the salt solutions are targeted for disposal (e.g. where the salt solutions are considered waste water), the concentrated salt solutions can be more efficiently disposed of. The skilled person will appreciate that reduced volumes will lead to reduced disposal costs. Also, the reduced volumes will necessarily be less taxing on disposal capacity.

Other exemplary targeted uses of the concentrated salt solutions include the extraction of desired metal ions from the concentrated salt solutions (i.e. metal ion reclamation). The skilled person will appreciate that as the salt solutions are concentrated, the weight of ions increases per unit volume. Stated differently, concentration of salt solutions decreases the volume of water that must be handled and/or processed to extract a given amount of desired metal ion. Therefore, while it may otherwise be cost prohibitive to extract metal ions, such as lithium or rare-earth metals, from many salt solutions due to the high cost of handling and/or processing the volumes of water that may be required to handle and process less concentrated salt solution, the systems and processes of the present invention advantageously provide concentrated salt solutions that can yield higher recovery of the targeted ion relative to the volume of water handled and/or processed.

In other exemplary uses, the concentrated brines are re-used in drilling and producing oil and gas. For example, this may include use in fluid for hydraulically fracturing a subterranean formation via a well, or in enhanced oil recovery operations.

As indicated above, aspects of the invention provide for the management of produced water streams. As the skilled person understands, water associated with the production of oil and gas is referred to as produced oilfield water or simply produced water. Produced water is generally classified as flowback water or formation water. Flowback water includes spent hydraulic fracturing (frac) fluid, which includes water and related additives used to hydraulically fracture the formation. Formation water includes water that was originally present in the formation.

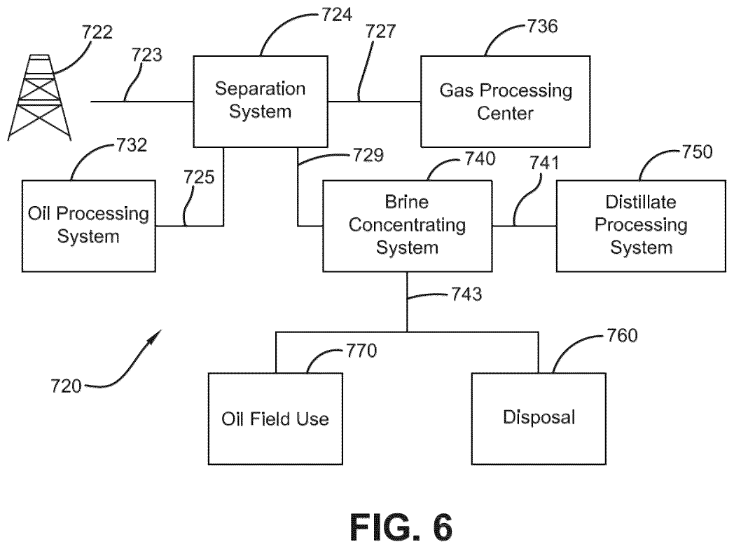

The water management methods of the present invention can be described with reference to FIG. 6, which depicts system 720 including one or more oil and/or gas production wells 722 that provide a multiphase production stream carried by conduit 723. The multiphase production stream generally includes a mixture of liquids and gases that include hydrocarbons (e.g. one or more of gas, condensate, and oil), water (which may further include dissolved minerals, such as salt), other gases (e.g. nitrogen, carbon dioxide (CO₂), hydrogen sulfide (H₂S)), and solids (e.g. salt, sand, and scale). Conduit 723 routes the multiphase production stream to a separator system 724, which ultimately separates the stream into an oil-rich stream that can be carried by conduit 725, a gas-rich stream that can be carried by conduit 727, and a water-rich stream that can be carried by conduit 729. Practice of this invention is not necessarily limited by the workings of separator system 724. For example, and as the skilled person understands, separator system 724 may include a multi-stage arrangement that may include a two-phase separator that produces a gas-rich stream and a liquid-rich stream. The liquid-rich stream may then subsequently be separated by a liquid-liquid separator to provide the oil-rich stream and the water-rich stream. Alternatively, three-way separators may by employed to produce the gas-rich, water-rich, and oil-rich streams. The oil-rich stream can then be routed, via conduit 725, to an oil-processing system 732 where the oil-rich stream may be treated in a conventional manner for subsequent use or sale. The gas-rich stream can be routed, via conduit 727, to a conventional gas processing center to be treated and managed.

In accordance with the present invention, the water-rich stream, which may be referred as a produced water stream, is routed to a brine-concentrating system 740 via conduit 729. It will be appreciated that brine-concentrating system 741 can include a vacuum distillation system of one or more embodiments of the present invention. It will also be appreciated that water-rich stream can be pre-treated prior to being treated within the brine-concentrating systems of the present invention. For example, the water-rich stream can undergo further separations to remove hydrocarbons entrained with the water-rich stream. In or more embodiments, the process of the present invention includes treating the water-rich stream to provide a stream that includes less than 3 wt %, in other embodiments less than 2 wt %, and in other embodiments less than 1 wt % hydrocarbon based on the total weight of the water-rich stream, prior to treating the water-rich stream within the vacuum distillation systems of the present invention.

Within brine-concentrating system 740, the water-rich stream undergoes distillation to provide a distillate stream and a residue stream, which may also be referred to as a highly-concentrated brine stream. The distillate stream can be carried by conduit 741 to a distillate processing center 750 where, for example, further processing may take place to produce a purified water stream. In one or more embodiments, the distillate stream can routed back to an oil field for use as will be described in greater detail below. The residue stream, which is carried by conduit 743, can be handled in one or more ways as described above; e.g. disposed of, re-used, or subjected to ion reclamation. For example, the highly-concentrated brine stream can be routed to disposal 760, which may include deep well disposal. In combination therewith or in the alternative, the highly-concentrated stream can be routed to an oil field 770 for use therein. For example, the highly-concentrated brine stream can be used in frac make-up water or in EOR operations. In other embodiments, the concentrated solutions can be further processed to recover metal ions.

In one or more embodiments, distillation is controlled to produce a concentrated brine stream that includes at least 1.1 times, in other embodiments at least 1.3 times, in other embodiments at least than 1.5 times, in other embodiments at least 1.7 times, in other embodiments at least 2.0 times, in other embodiments at least 2.3 times, in other embodiments at least 2.5 times, and in other embodiments at least 3.0 times the amount of total dissolved solids (TDS) as the produced water stream originally fed to the brine-concentrating step or system. In one or more embodiments, distillation is controlled to produce a concentrated brine stream that includes greater than 25,000 mg/L, in other embodiments greater than 50,000 mg/L, in other embodiments greater than 100,000 mg/L, in other embodiments greater than 150,000 mg/L, and in other embodiments greater than 200,000 mg/L total dissolved solids. Stated differently, distillation is controlled to produce a concentrated brine stream having a volume that is about 90% or less, in other embodiments about 77% or less, in other embodiments about 67% or less, in other embodiments about 50% or less, in other embodiments about 43% or less, in other embodiments about 40% or less, and in other embodiments about 33% or less of the volume of the produced water stream that is originally fed to the brine-concentrating step or system.

While the systems and methods of the present invention produced concentrated brine streams, the degree of concentration (e.g. distillation) is also controlled to produce a concentrated brine stream that remains below threshold levels for total solids (i.e. dissolved and/or suspended solids) to ensure the ability to handle the residue stream in a desired manner. For example, it may be desirable to maintain the total solids below levels necessary to maintain fluidity and the ability to pump the concentrated brine stream. For example, the total solids are maintained below levels to provide the concentrated brine stream with a Bingham Plastic viscosity of less than 100 centipoise (cP), in other embodiments less than 50 cP, and in other embodiments less than 25 cP. Suitable methods for determining the Bingham Plastic viscosity of the concentrated brine stream can be found in Chapter 4 of The Society of Petroleum Engineers Monograph Volume 4, Cementing by Dwight K. Smith, published in 1976 and the American Petroleum Institute (API) Recommended Practice 13B-1, 2^{nd}, edition, Standard Procedure for Field Testing Water-Based Drilling Fluids.

In other embodiments, the total dissolved solids are maintained below the saturation point of the concentrated brine solution. For example, the total dissolved solids of the concentrated brine solution can be maintained at less than 400,000 mg/L, in other embodiments less than 350,000 mg/L, in other embodiments less than 300,000 mg/L, and in other embodiments less than 250,000 mg/L. In one or more embodiments, the upper limit of the total dissolved solids content of the concentrated brine solution is entirely dependent upon the nature of the dissolved solids content of the influent water being distilled. For instance, the saturation content of a sodium chloride (NaCl) solution is about 26% (i.e., 260,000 mg/L) having a relative viscosity of 1.986, whereas the saturation content of a calcium chloride solution is about 40% (i.e., 400,000 mg/L) having a relative viscosity of 8.979. Seawater, by contrast, is not only a mixed salt solution, but has a dissolved solids content substantially less than that of a saturated sodium chloride or calcium chloride solution. As such, seawater has a salt content of about 3.5% (35,000 mg/L) and a relative viscosity of 1.067. An increase in the salinity of the concentrated seawater brine solution of approximately 1.71 times to 6% (i.e, 60,000 mg/) would yield a relative viscosity of the brine of 1.137 cP. As the skilled person appreciates, relative viscosity is defined as the ratio of the absolute viscosity of a solution at 20° C. to the absolute viscosity of water at 20° C. (Weast, CRC Handbook of Chemistry and Physics, 57^{th} ed., pg. D-218). The skilled person also appreciates that the absolute viscosity of brine solutions does not take into consideration suspended solids (Bingham plastic) effects, or gelation and/or emulsification effects produced by the carry-over of polymers, polymeric residue, and/or hydrocarbons (Power Law effects), which may substantially increase the viscosity of the concentrated brine product.

In one or more embodiments, the distillation process may include a continuous distillation process that can be adjusted in real time to provide a residue stream with a desired concentration of total solids (i.e. dissolved and/or suspended solids). According to these embodiments, the total solids of the produced water stream is determined before distillation. Likewise, the total solids of the concentrated brine stream (i.e. the residue stream) is determined following distillation. In view of this information, the distillation is adjusted to provide the desired residue stream. As the skilled person appreciates, several methods and techniques can be used to determine the dissolved and/or suspended solids content of either the produced water stream or the concentrated brine stream. For example, the skilled person understands that standardized testing for dissolved solids is provided at Section 2520, Standard Methods for the Examination of Water & Wastewater, 21^{st} ed., 2005, and standardized testing for suspended solids is provided at Section 2540, Standard Methods for the Examination of Water & Wastewater, 21^{st} ed., 2005. It will also be appreciated that total dissolved solids is often determined by electrical conductivity testing, which affords the opportunity to continuously monitor and provide real-time data on the dissolved solids content of solutions. Also, suspended solids can be determined based upon the turbidity of the water (e.g. ISO 7027 by measuring the incident light scattered at right angles from the sample). In yet other embodiments, distillation can be adjusted based upon information obtained relative to the viscosity of the concentrated brine solution. In those embodiments that include multiple stages of separation, the processes of the invention may include a determination of temperature, pressure, and brine concentration at each stage.

The systems and process designs of the present invention advantageously allow for large scale treatment of water. For example, the systems and processes of the present invention, especially fixed-base systems, are adapted to treat greater than 25,000, in other embodiments greater than 50,000, and in other embodiments greater than 100,000 barrels of salt solution per day. In other embodiments, the processes and systems of the invention can be configured to treat lower volumes of salt solutions, including those systems designed to treat from about 500 to about 25,000 barrels per day. These small systems may advantageously be configured and carried by road-rated mobile units.

Various modifications and alterations that do not depart from the scope and spirit of this invention will become apparent to those skilled in the art. This invention is not to be duly limited to the illustrative embodiments set forth herein.

1. A method for treating a salt solution, the method comprising:
(i) introducing a liquid motive fluid into an eductor;
(ii) drawing vapor from a distillation tank into the eductor, where said drawing reduces the pressure within the distillation tank;
(iii) mixing the motive fluid and the vapor within the eductor to produce a liquid stream, where the vapor condenses within said eductor and thereby releases heat and at least a portion of the heat is transferred to the liquid stream;
(iv) transferring at least a portion of the heat associated with the liquid stream to a salt solution; and
(v) distilling the salt solution within the distillation tank.

2. The method of claim 1, where said distillation tank is a second distillation tank in a series including a first distillation tank and a second distillation tank, and where said transferring heat associated with the liquid stream includes transferring the heat to an initial salt solution, distilling the initial salt solution within the first distillation tank to produce an initial vapor stream and an initial concentrated salt solution, and where said salt solution is said initial concentrated salt solution whereby said distilling the salt solution within the distillation tank is distilling the concentrated salt solution within the second distillation tank.

3. The method of claim 1, where said introducing a liquid motive fluid into an eductor is a first liquid motive fluid introduced to a first eductor, and further comprising introducing a second liquid motive fluid into a second eductor.

4. The method of claim 2, where said initial vapor stream is condensed within a heat exchanger in thermal communication with concentrated salt solution, and where the second eductor draws the condensate of the initial vapor stream from the heat exchanger.

5. The method of claim 2, where said distillation tank is a final distillation tank in a series of distillation tanks, said series including an initial distillation tank, an intermediary stage including one or more intermediary distillation tanks, and where said transferring heat associated with the liquid stream includes transferring the heat to an initial salt solution, distilling the initial salt solution within the initial distillation tank to produce an initial vapor stream and an initial concentrated salt solution, condensing the initial vapor stream to release heat of condensation associated with the initial vapor stream, transferring at least a portion of the heat of condensation associated with the initial vapor stream to the intermediary stage, transferring the initial concentrated salt solution to the intermediary stage, distilling the concentrated salt solution within the intermediary stage to produce an intermediary vapor stream and intermediary concentrated salt solution, condensing the intermediary vapor stream to release heat of condensation associated with the stream, transferring at least a portion of the heat of condensation associated with the intermediary vapor stream and the concentrated salt solution to the final distillation tank, and distilling the distilling the final concentrated salt solution to produce a final vapor stream and a final concentrated salt solution and where said salt solution is said initial concentrated salt solution whereby said distilling the salt solution within the distillation tank is distilling the concentrated salt solution within the second distillation tank.

6. The method of claim 1, where said transferring at least a portion of the heat associated with the liquid stream to a salt solution takes place within the distillation tank via a first heat exchanger disposed within the distillation tank, and further comprising directing the motive fluid through the first heat exchanger and then to a second heat exchanger disposed outside of the distillation, where the second heat exchanger is in thermal communication with the salt solution prior to introducing the salt solution to the distillation tank.

7. The method of claim 6, where the second heat exchanger is disposed within a pre-treatment tank, and the where the salt solution is introduced to the pre-treatment tank prior to being introduced to the distillation tank, and further comprising the step of chemically treating the salt solution within the pre-treatment tank.

8. The method of claim 1, where the salt solution is produced water.

9. The method of claim 1, where the method produces a concentrated salt solution that is transferred to disposal, reclamation, or use within an oilfield operation.

10. A process for treating a salt solution, the method comprising:
(i) condensing a vapor stream to form a first condensed stream and thereby release heat of condensation associated with the vapor stream;
(ii) transferring at least a portion of the heat associated with the vapor stream to a salt solution to provide a first heated salt solution;
(iii) separating the first heated salt solution into a first vapor stream and a first concentrated salt solution stream, where said separating takes place within a first tank;
(iv) transferring the first concentrated salt solution to a second tank;
(v) condensing the first vapor stream to form a second condensed stream and thereby release heat of condensation associated with the first vapor stream;
(vi) transferring at least a portion of the heat associated with the first vapor stream to the first concentrated salt solution stream to thereby form a second heated salt solution; and
(vii) separating the second heated salt solution into a second vapor stream and a second concentrated salt solution stream, where said separating the second heated salt solution takes place with a second tank.

11. The process for treating a salt solution of claim 10, where said condensing a vapor stream to release the heat of condensation includes condensing of said second vapor stream.

12. The process for treating a salt solution of claim 10, further comprising introducing a first liquid motive fluid to a first eductor, drawing the second vapor stream into the first eductor, and mixing the second vapor stream and the liquid motive fluid within the first eductor; and
where condensing said second vapor stream takes place within the first eductor.

13. The process for treating a salt solution of claim 10, further comprising introducing a second liquid motive fluid to a second eductor, drawing the second condensed stream into the second eductor, and mixing the second condensed stream and the second liquid motive fluid within the second eductor.

14. The process for treating a salt solution of claim 10, further comprising transferring the second concentrated salt solution to disposal.

15. A multi-stage process for treating a salt solution, the process comprising:
(i) providing an initial salt solution to an initial distillation stage,
(ii) distilling the initial salt solution within the initial distillation stage to thereby produce an initial vapor stream and an initial concentrated salt solution;
(iii) transferring the initial vapor stream and initial concentrated salt solution to an intermediary distillation stage;
(iv) condensing the initial vapor stream to thereby release the heat of condensation associated with the initial stream;
(v) converting, within the intermediary distillation stage, at least a portion of the initial concentrated salt solution an intermediary vapor stream and an intermediary concentrated salt solution;
(vi) transferring the intermediary vapor stream and intermediary concentrated salt solution to a final distillation stage, wherein the final distillation stage produces a final vapor stream and a final concentrated salt solution;
(vii) condensing the final vapor stream to thereby release the heat of condensation associated with the final vapor stream;
(viii) transferring at least a portion of the heat of condensation associated with the final vapor stream to the initial salt solution; and
(ix) capturing at least a portion of the final concentrated salt solution.

16. The multi-stage process for treating a salt solution of claim 15, where the intermediary distillation stage includes a first substage wherein heat of condensation associated with the initial stream is transferred to the initial concentrated salt solution and the initial concentrated salt solution is distilled to produce a first substage vapor stream and a first substage concentrated salt solution, where the first substage vapor stream is condensed to thereby release the heat of condensation associated with the first substage vapor stream, and where the intermediary distillation stage includes a second substage wherein the heat of condensation associated with the first substage vapor stream is transferred to the first substage concentrated salt solution and the first substage concentrated salt solution is distilled to produce a second substage vapor stream and a second substage concentrated salt solution.

17. The multi-stage process for treating a salt solution of claim 16, where said second substage vapor stream is said intermediary vapor stream, and where said second substage concentrated salt solution is said intermediary salt solution.

18. The multi-stage process for treating a salt solution of claim 16, wherein said intermediary distillation stage further includes a third substage wherein heat of condensation associated with the second substage vapor stream is transferred to the second substage concentrated salt solution and the second concentrated salt solution is distilled to produce a third substage vapor stream and a third substage concentrated salt solution.

19. The multi-stage process for treating a salt solution of claim 18, where said third substage vapor stream is said intermediary vapor stream, and where said third substage concentrated salt solution is said intermediary salt solution.

20. The multi-stage process for treating a salt solution of claim 18, wherein said intermediary distillation stage further includes a fourth substage wherein heat of condensation associated with the third substage vapor stream is transferred to the third substage concentrated salt solution and the third concentrated salt solution is distilled to produce a fourth substage vapor stream and a fourth substage concentrated salt solution.

21. (canceled)

22. (canceled)

23. (canceled)

24. (canceled)

25. (canceled)

26. (canceled)

27. (canceled)

28. (canceled)

29. (canceled)

30. (canceled)

31. (canceled)

32. (canceled)

33. (canceled)

34. (canceled)

35. (canceled)

36. (canceled)

37. (canceled)

38. (canceled)
